(19) United States
(12) Patent Application Publication
(10) Pub. No.: US 2004/0025507 A1
(43) Pub. Date: Feb. 12, 2004

(54) Turbo compressor for use in OBIGGS application

(75) Inventors: James E. Leigh, Palos Verdes Estates, CA (US); Timothy P. Birbeck, Manhattan Beach, CA (US); Giorgio Carlo Isella, Pasadena, CA (US)

Correspondence Address: Honeywell International, Inc., Law Dept. AB2, P.O. Box 2245, Morristown, NJ, 07962-9806, US

(73) Assignee: Honeywell International Inc., Morristown, NJ

(21) Appl. No.: 10/358,774

(22) Filed: Feb. 3, 2003

Related U.S. Application Data
(60) Provisional application No. 60/400,883, filed on Aug. 2, 2002.

(51) Int. Cl. F02B 33/44

(52) U.S. Cl. 60/608; 60/612; 123/563

(57) ABSTRACT

An on-board inert gas generating system (OBIGGS) uses a turbine in order to recover the energy of compression of the nitrogen-enriched product gas. This energy is transferred, through a shaft, to the compressor, which supplies compressed air to the separation membrane. Unlike conventional systems, where there is no means for recovering the energy of the compressed nitrogen enriched product air, the present system provides a cooled nitrogen-enriched gas to be supplied to a fuel tank ullage without losing the energy stored in the compressed nitrogen-enriched product gas.

### CROSS-REFERENCE TO RELATED APPLICATIONS

The present application claims the benefit of U.S. Provisional Application No. 60/400,883 filed Aug. 2, 2002

### BACKGROUND OF THE INVENTION

The present invention generally relates to an on-board inert gas generating system (OBIGGS) and method for generating inert gas. More specifically, the present invention relates to an OBIGGS having a turbo-compressor for warming and pressurizing feed air through an OBIGGS used for creating an inert atmosphere in the fuel tank ullage.

Many vehicles use internal combustion engines to operate, whether the engines are piston, rotary or turbine engines. These vehicles include automobiles, trucks, trains, airplanes, ships, boats and the like. All of these vehicles require highly combustible fuel in the form of gasoline, kerosene, fuel oil, petroleum products or other combustible fuels. These fuels present a safety hazard as the fuel is often contained in a fuel tank which contains a large amount of air as the tank empties. Evaporation of the fuel into the fuel tank ullage can create a combustible fuel-air mixture.

These engines and fuels are also used with stationary facilities such as power generation plants, petroleum refineries, co-generation facilities and manufacturing plants that use petroleum based fuels to activate equipment or produce flammable fluids. For these stationary facilities, the use of the flammable fuels also presents a safety hazard. Additionally, the storage of fuel for these facilities presents a large concern because the storage tanks containing flammable liquid are often large. As the tank empties, a large volume of fuel evaporates into the larger ullage of the storage tank, presenting the likelihood of a more powerful explosion if the fuel in the tank is ignited.

Due to the risk of explosion, some vehicles, particularly aircrafts, have been equipped with OBIGGS. The OBIGGS are intended to provide a supply of nitrogen enriched gas to fill the ullage in the fuel tank in order to lower its oxygen content and thereby reduce the possibility of an explosion.

WO 00/00389 discloses a method and system for providing nitrogen-enriched air to aircraft fuel tanks using multiple air separation modules. Each of these air separation modules is designed to have different permeabilities and selectivities which are particularly selected to meet the varying nitrogen-enriched air needs of the fuel tanks during various times during flight. Such a conventional two-stage approach uses compressed air that is optionally heated, to pass through a permeation membrane. The nitrogen-enriched air is then cooled, if necessary, and supplied to the fuel tank ullage.

Various further OBIGGS have been proposed in the art. For example, U.S. Pat. Nos. 5,918,679 and 2,756,215 use combustion product gases, having a deficiency of oxygen, to be supplied to the fuel tank ullage. These systems require various processing and temperature adjustments prior to using the oxygen deficient air in the fuel tank ullage.

Despite various advances, there remains a continuing need in the art for OBIGGS that have reduced size, weight and operating cost, but yet can provide a sufficient amount and purity of nitrogen-enriched gas to create an inert atmosphere in, for example, aircraft fuel tanks.

### SUMMARY OF THE INVENTION

In one aspect of the present invention, a gas generating system comprises a turbine driven by an air source; an auxiliary power device providing rotational drive for a shaft; a compressor driven by the shaft rotated by the turbine and the auxiliary power device, the compressor receiving an air supply to provide a pressurized air source; a membrane module assembly receiving the pressurized air source, the membrane module assembly providing pressurized nitrogen enriched air; and the pressurized nitrogen enriched air providing both the air source to drive the turbine and a nitrogen enriched air supply.

In another aspect of the present invention, a system for generating nitrogen enriched air comprises a turbine driven by an air source; an electric motor; a compressor driven by a shaft rotated by the turbine and the electric motor, the compressor receiving an air supply to provide a pressurized air source; a membrane module assembly receiving the pressurized air source, the membrane module assembly providing pressurized nitrogen enriched air; and a first heat exchanger located between the compressor and the membrane module assembly; the pressurized nitrogen enriched air providing both the air source to drive said turbine and the nitrogen enriched air.

In yet another aspect of the present invention, a system for generating nitrogen enriched air comprises a turbine driven by an air source; a power balance turbine driven by a pressurized air supply; a compressor driven by a shaft rotated by the turbine and the power balance turbine, the compressor receiving an air supply to provide a pressurized air source; a membrane module assembly receiving the pressurized air source, the membrane module assembly providing pressurized nitrogen enriched air; and a first heat exchanger located between the compressor and the membrane module assembly; the pressurized nitrogen enriched air providing both the air source to drive the turbine and the nitrogen enriched air.

In a further aspect of the present invention, a system for generating nitrogen enriched air comprises a turbine driven by an air source; a power balance turbine driven by a pressurized air supply; a compressor driven by a shaft rotated by the turbine and the power balance turbine, the compressor receiving an air supply to provide a pressurized air source; a membrane module assembly receiving the pressurized air source, the membrane module assembly providing pressurized nitrogen enriched air; a filter for providing a clean pressurized air source to the membrane module assembly; a first heat exchanger located between the compressor and the membrane module assembly, wherein expansion of the pressurized air supply creates a cooled air supply for the first heat exchanger; a second heat exchanger located between the air supply and the compressor, where the cooled air supply passing through the first heat exchanger is used as a cooled air supply for the second heat exchanger; and a third heat exchanger located between the compressor and the membrane module, wherein ram air is used as a coolant; the pressurized nitrogen enriched air providing both the air source to drive the turbine and the nitrogen enriched air.

In still a further aspect of the present invention, a method for making a nitrogen enriched air comprises rotationally driving a shaft with a turbine and an auxiliary power device to drive a compressor; compressing an air supply with the compressor to provide a pressurized air source; passing the pressurized air source through a membrane module assembly to generate a pressurized nitrogen enriched air; and driving the turbine with the pressurized enriched air to provide the nitrogen enriched air.

These and other features, aspects and advantages of the present invention will become better understood with reference to the following drawings, description and claims.

### BRIEF DESCRIPTION OF THE DRAWINGS

FIG. 1 is a schematic view of an OBIGGS according to an embodiment of the present invention;

FIG. 2 is a schematic view of an OBIGGS according to a first alternate embodiment of the present invention; and

FIG. 3 is a schematic view of an OBIGGS according to a second alternate embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention provides an OBIGGS using a turbine in order to recover the energy of compression of the nitrogen-enriched product gas. This energy is transferred, through a shaft, to the compressor, which supplies compressed air to the separation membrane. Such a system provides a cooled nitrogen-enriched gas to be supplied to a fuel tank ullage without losing the energy stored in the compressed nitrogen-enriched product gas.

Conventional multiple-stage approaches use compressed air that is optionally heated, then pass through a separation membrane. The nitrogen-enriched air is then cooled, if necessary, and supplied to the fuel tank ullage. Such conventional OBIGGS have no built in means for recovering the energy of the compressed nitrogen-enriched product air.

Conventional systems may also take the approach of using combustion product gases, having a deficiency of oxygen, to be supplied to the fuel tank ullage. These systems, however, require various processing and temperature adjustments prior to using the oxygen deficient air in the fuel tank ullage.

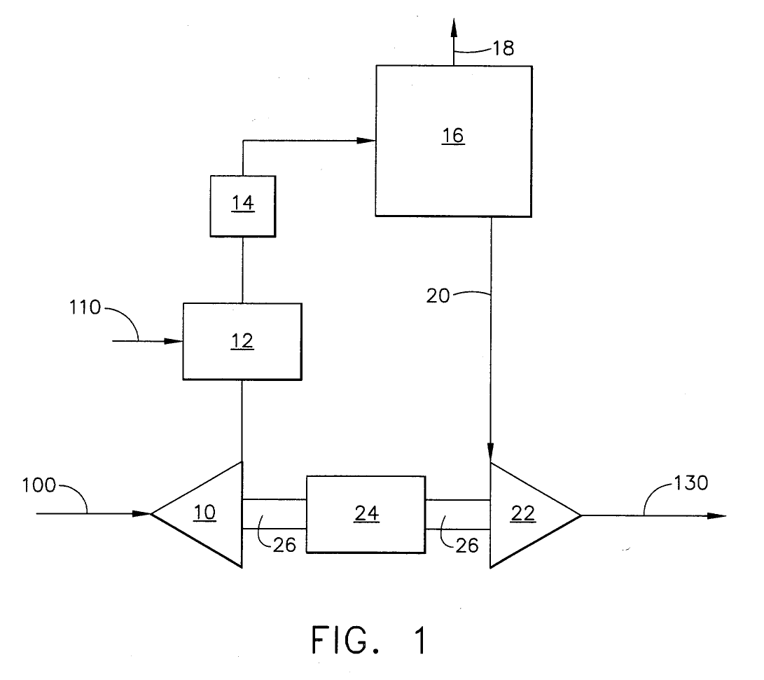

Referring to FIG. 1, there is shown a schematic drawing showing the OBIGGS according to one embodiment of the present invention. An air source is supplied, via arrow 100, to compressor 10. The air source may be ambient air, cabin outflow air, cabin recirculated air, engine bleed air, ram air, and the like. The air from compressor 10 is optionally conditioned to a predetermined temperature by means of a heat exchanger 12. Heat exchanger 12 may use ram air, via arrows 110, for example, as a cooling media if cooling of the output air from compressor 10 is necessary.

A filter 14 may receive conditioned air from heat exchanger 12. Filter 14 may remove dust particles, aerosol particles, vapors, liquid water and the like from the compressed air. Filter 14 may be selected from any conventional filter designed for dust particles, aerosol particles, vapors, liquid water and the like from an air stream. Filter 14 may be similar to that as described in U.S. Pat. No. 4,681,602, herein incorporated by reference.

The compressed air is then fed into a membrane module assembly 16. Membrane module assembly 16 may provide at least two distinct outputs. A first output 18 provides oxygen enriched air which may be vented to the exterior, conditioned into emergency oxygen, or routed to an environmental control system as therapeutic oxygen enriched air. A second output 20 provides high pressure nitrogen-enriched air.

Membrane module assembly 16, having such properties, is known in the art. They are generally referred to as high performance membranes. For example, but without limitation, the membrane material in membrane module assembly 16 may be a cellulose derivative, polyamide, polyimide, polyamideimide, polysulfone, copolymers and blends thereof. The membrane material is preferably in the form of homogeneous, asymmetric, or composite hollow fibers, but may be in roll form, and plate and frame cartridges. Membrane module assembly 16 may be selected from those described in U.S. Pat. Nos. 4,230,463; 4,681,605; 4,983,191; 5,015,270; 5,085,676; and 5,096,468; the contents of which are hereby incorporated by reference.

This invention is particularly well suited for use with membranes which are designed to operate at particularly high temperatures. Since permeability through a membrane increases with increasing temperature, a higher operating temperature translates to a smaller total membrane area required. The combination of high temperature capability and resulting high material permeability allows a high temperature membrane module assembly 16 to have significant size and weight advantages over those made from conventional membrane materials and structures.

In addition, cooling requirements for the feed air are reduced when operating at a higher temperature. The result is a reduction, or possible elimination, of the heat exchanger and associated cooling flow.

Finally, turbine inlet temperature has a direct effect on the power input from the turbine. Increasing membrane operating temperature has the effect of increasing turbine power output. The end result is a savings in power consumption (whether from electricity or high pressure air) required to power the turbomachinery.

The pressurized nitrogen enriched air may drive a turbine 22. This release of energy in the pressurized nitrogen enriched air cools the air to a temperature suitable to be used in the nitrogen enriched air distribution system (not shown) via arrow 130. This distribution system may provide nitrogen enriched air to, for example, the fuel tank ullage as explosion prevention or to the cargo bay of an aircraft as fire suppression.

Turbine 22 may be used to drive compressor 10 via a shaft 26. Therefore, the energy lost in depressurizing the nitrogen enriched air is constructively used in the OBIGGS of the present invention. An electric motor 24 may be connected in series with turbine 22 to provide additional power, as needed, to drive compressor 10. However, additional power may not be needed if the air going to compressor 10 is already compressed.

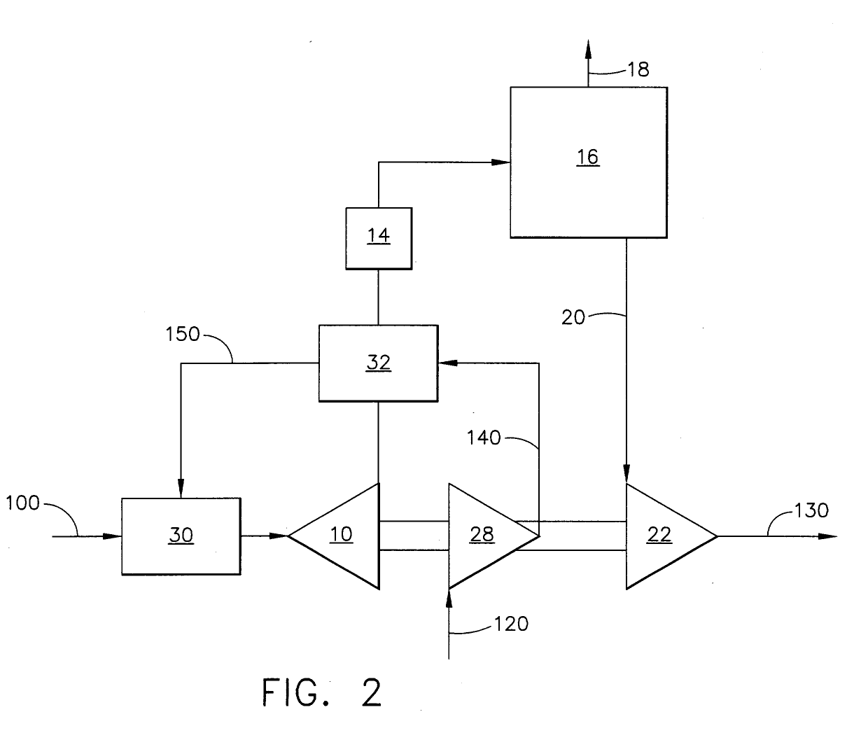

Referring now to FIG. 2, there is shown an alternate configuration of the OBIGGS of the present invention. Electric motor 24 of the embodiment of FIG. 1, may be replaced by a power balance turbine 28 driven by a pressurized air source, delivering pressurized air via arrow 120, such as a high pressure engine bleed (not shown). Power balance turbine 28 is connected in series, via shaft 26, with turbine 22 to power compressor 10.

The cooled expanded air that leaves power balance turbine 28 may be used as a cooling source, via arrow 140, for heat exchanger 32. A supplemental heat exchanger 30 may be provided to regulate the temperature of the air source prior to entering compressor 10. Supplemental heat exchanger 30 may also be fed, via arrow 150, a source of cooled air that results from the expanding air driving power balance turbine 28.

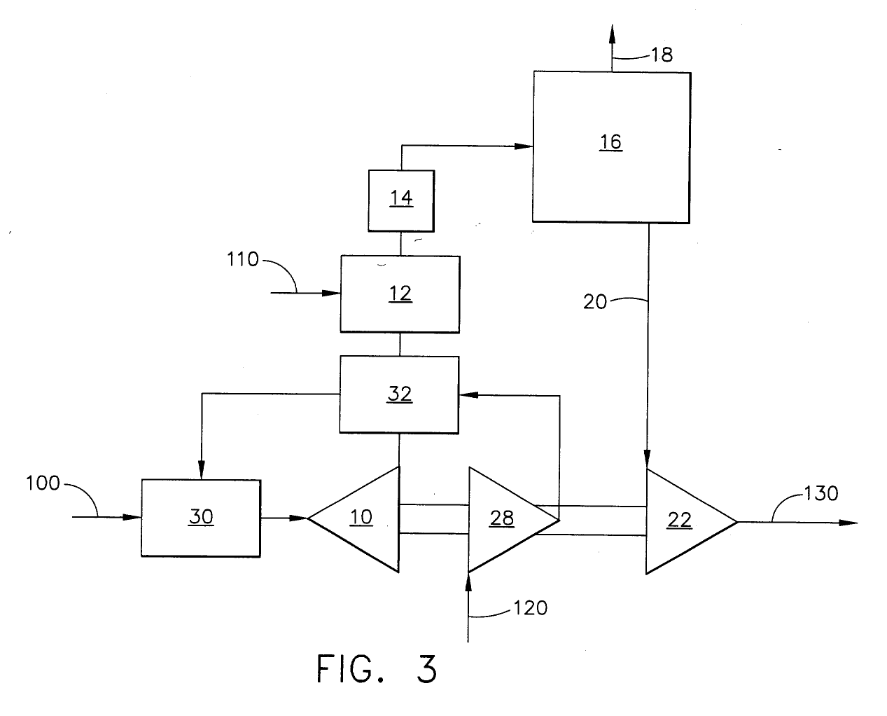

Referring now to FIG. 3, there is shown a second alternate embodiment of the OBIGGS of the present invention. The embodiment of FIG. 3 is a hybrid between the embodiments of FIGS. 1 and 2. That is, the embodiment of FIG. 3 includes heat exchanger 12, cooled by a ram air cooling source, and heat exchangers 30 and 32, cooled by expanded air that drives power balance turbine 28. The remaining elements of FIG. 3 are the same as those of FIGS. 1 and 2.

While the present invention has been described with a focus on using nitrogen enriched air to inert fuel tanks on aircraft, the present invention is not limited as such. The OBIGGS of the present invention may be used to provide a source of nitrogen enriched air wherever such air may be needed. This includes the use of nitrogen enriched air to inert fuel tanks on vehicles and storage facilities, as well the use of nitrogen enriched air as a fire suppressant in, for example, the cargo hold of ships or aircraft.

It should be understood, of course, that the foregoing relates to preferred embodiments of the invention and that modifications may be made without departing from the spirit and scope of the invention as set forth in the following claims.

We claim:

1. A gas generating system comprising:
a compressor that provides compressed air;
a membrane module assembly that provides nitrogen-enriched compressed air from said compressed air; and
a turbine, driven by said nitrogen-enriched compressed air, that provides power for said compressor.

2. The gas generating system according to claim 1, further comprising an auxiliary power device providing supplemental power for said compressor.

3. The gas generating system according to claim 2 wherein said auxiliary power device is an electric motor.

4. The gas generating system according to claim 1 wherein an air supply for said compressor is at least one of cabin air, engine bleed air, and ram air.

5. The gas generating system according to claim 1 further comprising a first heat exchanger located between said compressor and said membrane module assembly.

6. The gas generating system according to claim 5 wherein said first heat exchanger uses ram air as a coolant.

7. The gas generating system according to claim 1 further comprising a filter for filtering said compressed air supplied to said membrane module assembly.

8. The gas generating system according to claim 1 further comprising a second heat exchanger that conditions air supplied to said compressor.

9. The gas generating system according to claim 2 wherein said auxiliary power device is a power balance turbine driven by a pressurized air supply.

10. The gas generating system according to claim 9 wherein said pressurized air supply is high pressure engine bleed air.

11. The gas generating system according to claim 9 further comprising a first heat exchanger located between said compressor and said membrane module assembly, wherein expansion of said pressurized air supply creates a cooled air supply for said first heat exchanger.

12. The gas generating system according to claim 11 further comprising a second heat exchanger to condition air supplied to said compressor, where said cooled air supply passing through said first heat exchanger is used as a cooled air supply for said second heat exchanger.

13. The gas generating system according to claim 12 further comprising a third heat exchanger located between said compressor and said membrane module, wherein ram air is used as a coolant.

14. A system for generating nitrogen enriched air comprising:
a turbine driven by an air source;
an electric motor;
a compressor driven by a shaft rotated by said turbine and said electric motor, said compressor receiving an air supply to provide a pressurized air source;
a membrane module assembly receiving said pressurized air source, said membrane module assembly providing pressurized nitrogen enriched air; and
a first heat exchanger located between said compressor and said membrane module assembly;
said pressurized nitrogen enriched air providing both said air source to drive said turbine and said nitrogen enriched air.

15. The system for generating nitrogen enriched air according to claim 14 wherein said first heat exchanger uses ram air as a coolant.

16. The system for generating nitrogen enriched air according to claim 14 further comprising a filter for providing a clean pressurized air source to said membrane module assembly.

17. A system for generating nitrogen enriched air comprising:
a turbine driven by an air source;
a power balance turbine driven by a pressurized air supply;
a compressor driven by a shaft rotated by said turbine and said power balance turbine, said compressor receiving an air supply to provide a pressurized air source;
a membrane module assembly receiving said pressurized air source, said membrane module assembly providing pressurized nitrogen enriched air; and
a first heat exchanger located between said compressor and said membrane module assembly;
said pressurized nitrogen enriched air providing both said air source to drive said turbine and said nitrogen enriched air.

18. The system for generating nitrogen enriched air according to claim 17, wherein expansion of said pressurized air supply creates a cooled air supply for said first heat exchanger.

19. The system for generating nitrogen enriched air according to claim 17, further comprising a filter for providing a clean pressurized air source to said membrane module assembly.

20. The system for generating nitrogen enriched air according to claim 17, wherein said pressurized air supply is high pressure engine bleed air.

21. The system for generating nitrogen enriched air according to claim 17, further comprising a second heat exchanger located between said air supply and said compressor, where said cooled air supply passing through said first heat exchanger is used as a cooled air supply for said second heat exchanger.

22. The system for generating nitrogen enriched air according to claim 17, further comprising a third heat exchanger located between said compressor and said membrane module, wherein ram air is used as a coolant.

23. A system for generating nitrogen enriched air comprising:
a turbine driven by an air source;
a power balance turbine driven by a pressurized air supply;
a compressor driven by a shaft rotated by said turbine and said power balance turbine, said compressor receiving an air supply to provide a pressurized air source;
a membrane module assembly receiving said pressurized air source, said membrane module assembly providing pressurized nitrogen enriched air;
a filter for providing a clean pressurized air source to said membrane module assembly;
a first heat exchanger located between said compressor and said membrane module assembly, wherein expansion of said pressurized air supply creates a cooled air supply for said first heat exchanger;
a second heat exchanger located between said air supply and said compressor, where said cooled air supply passing through said first heat exchanger is used as a cooled air supply for said second heat exchanger; and
a third heat exchanger located between said compressor and said membrane module, wherein ram air is used as a coolant;
said pressurized nitrogen enriched air providing both said air source to drive said turbine and said nitrogen enriched air, said nitrogen enriched air being used to inert a fuel tank ullage.

24. A method for making a nitrogen enriched air comprising:
compressing air to generate a compressed air;
passing said compressed air through a membrane module assembly to obtain nitrogen-enriched compressed air;
driving a turbine with said nitrogen-enriched compressed air; and
using power from said turbine to compress said air.

25. The method according to claim 24, further comprising providing an auxiliary power device to provide supplemental power to compress said air.

26. The method according to claim 25, further comprising providing an electric motor as said auxiliary power device.

27. The method according to claim 24, further comprising providing a first heat exchanger between said compressor and said membrane module assembly.

28. The method according to claim 24, further comprising filtering said compressed air.

29. The method according to claim 25, further comprising:
providing a power balance turbine as said auxiliary power device; and
driving said power balance turbine with a pressurized air supply.

30. The method according to claim 29, further comprising providing a first heat exchanger located between said compressor and said membrane module assembly, wherein expansion of said pressurized air supply creates a cooled air supply for said first heat exchanger.

31. The method according to claim 30, further comprising providing a second heat exchanger to condition said air prior to compression, where said cooled air supply passing through said first heat exchanger is used as a cooled air supply for said second heat exchanger.

32. The method according to claim 31, further comprising providing a third heat exchanger located between said compressor and said membrane module, wherein ram air is used as a coolant.
